(19) United States
(12) Patent Application Publication
(10) Pub. No.: US 2004/0258573 A1
(43) Pub. Date: Dec. 23, 2004

(54) System for proportioning sample liquid

(76) Inventor: Rainer Treptow, Norderstedt (DE)

Correspondence Address: VIDAS, ARRETT & STEINKRAUS, P.A., 6109 BLUE CIRCLE DRIVE, SUITE 2000, MINNETONKA, MN, 55343-9185, US

(21) Appl. No.: 10/863,410

(22) Filed: Jun. 8, 2004

(30) Foreign Application Priority Data
Jun. 18, 2003 (DE) 103 27 380.8

(51) Int. Cl. B01L 3/02

(52) U.S. Cl. 422/100; 141/83

(57) ABSTRACT

A system for proportioning sample liquids, comprising

at least one proportioning module prefilled with a sample liquid which has a module casing in which a displacement chamber is disposed and has an outwardly leading proportioning outlet,

at least one device for storing proportioning modules,

at least one proportioning apparatus with a device for locating at least one proportioning module on the proportioning apparatus and releasing the proportioning module from the proportioning apparatus, and a device for actuating the displacement chamber of the proportioning module located on the proportioning apparatus,

at least one device for storing substrates onto which a sample liquid is to be proportioned,

a device for shifting the proportioning apparatus with respect to the device for storing proportioning modules and the device for storing substrates for an exchange of proportioning modules between the proportioning apparatus and the device for storing proportioning modules, and for the proportioning of sample liquids onto substrates on the device for storing substrates, and

a control device connected to the devices for locating and releasing and actuating the proportioning apparatus and the shifting device.

### CROSS-REFERENCE TO RELATED APPLICATIONS

Not applicable.

### STATEMENT REGARDING FEDERALLY SPONSORED RESEARCH

Not applicable.

### BACKGROUND OF THE INVENTION

Known systems for proportioning sample liquids operate with pipette tips of plastic or steel which are dipped into receptacles containing a sample liquid at least during liquid reception. These systems are run manually or automatically. Plastic tips require to be exchanged after use and steel tips require to be subjected to thorough cleaning with a high demand of rinsing liquid to avoid contaminations or carry-overs. Nevertheless, contaminations and carry-overs cannot be ruled out.

WO 99/10099 discloses various microproportioning systems which are conceived for proportioning volumes in the range from a few nanolitres to some microlitres and are operated with a open-jet proportioner and/or micro-diaphragm pump. The systems concerned are of the direct displacement types in which the sample liquid to be proportioned is directly displaced by a diaphragm of the open-jet proportioner or micro-diaphragm pump. The open-jet proportioner or micro-diaphragm pump and a reservoir for a sample liquid to be proportioned are combined in a proportioning module which can be exchangeably connected to a proportioning apparatus. To this end, the proportioning apparatus has a reception canal into which the proportioning module is inserted, at its lower end. The proportioning module is retained by a holding mechanism which is caused to work by the axial movement of inserting the proportioning module into the reception canal. The proportioning apparatus has an actuator associated with the reception canal which bears against the diaphragm of the proportioning module with no gap to actuate the displacement device. Actuating the actuator can cause the proportioning module to eject liquid from the proportioning outlet. The proportioning modules disclosed are those which have been prefilled with sample liquid before being inserted into the proportioning apparatus. Those are one-way components, which can be thrown away after use, or are components which are usable several times.

DE 101 33 062 A1 discloses a system which makes it possible to keep proportioning modules inside and outside proportioning apparatus in a protected manner and makes it easier to load proportioning apparatus with proportioning modules and to remove proportioning modules from proportioning apparatus. The system comprises a proportioning module, a proportioning apparatus with a seat for the proportioning module, and a receptacle having a further seat for the proportioning module. Shifting the proportioning apparatus by hand is inaccurate and can result in contaminations of the proportioning modules or wells into which the sample liquid is proportioned by hand.

Accordingly, it is the object of the invention to provide a system for proportioning sample liquids onto any substrates which further reduces the risk of contamination and carry-over.

### BRIEF SUMMARY OF THE INVENTION

The inventive system for proportioning sample liquids has at least one proportioning module prefilled with a sample liquid which has a module casing in which a displacement chamber is disposed and has an outwardly leading proportioning outlet, at least one device for storing proportioning modules, at least one proportioning apparatus with a device for locating at least one proportioning module on the proportioning apparatus and releasing the proportioning module from the proportioning apparatus, and a device for actuating the displacement chamber of the proportioning module located on the proportioning apparatus, at least one device for storing substrates onto which a sample liquid is to be proportioned, a device for shifting the proportioning apparatus with respect to the device for storing proportioning modules and the device for storing substrates for an exchange of proportioning modules between the proportioning apparatus and the device for storing proportioning modules, and for the proportioning of sample liquids onto substrates on the device for storing substrates, and a control device connected to the devices for locating and releasing and actuating the proportioning apparatus and the device for shifting.

In the inventive system, the proportioning apparatus is automatically loaded with proportioning modules from the device for storing proportioning modules and, after use, proportioning modules are automatically delivered to a device for storing proportioning modules. At this point, the relative movement of the proportioning apparatus and the device for storing proportioning modules is caused by the device for shifting, the device for shifting being controlled by the control device. The proportioning apparatus, with respect to the device for shifting, is brought to a position in which the proportioning apparatus, via the control of the device for locating or the device for releasing, is connected to a proportioning module from the device for storing or delivers a proportioning module to the device for storing. Further, sample liquid is proportioned onto substrates automatically. The proportioning apparatus is shifted with respect to the device for storing substrates so that the proportioning module with its proportioning outlet is oriented to the desired point of delivery of the substrate. At this point, the relative movement of the proportioning apparatus and the device for storing substrates is caused by the device for shifting, which is controlled by the control device. The proportioning procedure is automatically controlled by the control device by driving the device for actuating the displacement chamber. Since prefilled proportioning modules are employed there is no need to dip proportioning apparatus into the sample liquid. Further, the sample liquid can be proportioned onto the substrates in an open jet in a non-contacting way. The liquid can be proportioned onto substrates having minimum dimensions, particularly in wells of highly densified microtitration plates or base boards having minimum dimensions to which a multiplicity of punctiform liquid samples require to be applied (“spotted”). Since dipping and contacting are avoided as the procedures are automatic contaminations and carry-overs are prevented and pipette tips need not be rinsed in a time-consuming way. There are no longer the disadvantages of manually handling proportioning modules for volumes going down into the nanolitre range.

The proportioning modules can be of different configurations. In particular, the proportioning modules are designed with a reservoir, a micro-diaphragm pump and/or an open-jet proportioner according to WO 99/10099 and/or are configured like a microfluidic storage and/or proportioning component according to EP 1 256 543 A2 the features of which are incorporated into the present application individually or in any combination by way of reference to the foregoing documents.

Various aspects are possible for the device for storing proportioning modules. According to an aspect, the device for storing proportioning modules has at least one receptacle for keeping proportioning modules and/or at least one handling frame for handling receptacles and/or proportioning modules and/or at least one tray for receiving proportioning modules and/or handling frames and/or receptacles. The receptacle and/or handling frame and/or tray are specifically configured like the receptacle and/or the strip-shaped top part (which corresponds to the handling frame) and/or the tray in accordance with DE 101 33 062 A1 the features of which are incorporated into the present application both individually or in any combination by way of reference to this document. This particularly applies to the technique of connection between the proportioning module, proportioning apparatus, receptacle, handling frame, and tray as well as the sealing of the proportioning module within the receptacle.

According to an aspect, the device for storing proportioning modules, the device for storing proportioning modules comprises at least one temperature-controllable tray. Storing prefilled proportioning modules in a temperature-controllable tray allows to extend storage periods and/or set the sample liquid to a determined reaction temperature already prior to proportioning. According to an aspect, the temperature-controllable tray is a cooling block. One aspect relates to a temperature-controllable tray which exhibits the features of the tray configured as a device for temperature control according to DE 101 33 062 A1.

According to an aspect, the device for storing proportioning modules comprises a plurality of proportioning modules containing various sample liquids. The proportioning modules have sample liquids which are destined for various applications. The so configured device for storing proportioning modules constitutes a “library” with application specific sample liquids from which the system selects in accordance with the application. This is controlled by the control device.

The proportioning device may be configured in different ways. According to an aspect, it has the features of the actuation module of WO 99/10099 A1 which are incorporated into the present application individually or in any combination by way of reference to this document. According to an aspect, the proportioning apparatus has the features of the proportioning apparatus according to DE 101 33 062 A1 which are incorporated into the present application individually or in any combination by way of reference to this document.

According to an aspect, the proportioning apparatus has the features of the proportioning apparatus according to DE 100 39 735 C2 which are incorporated into the present by way of reference to this document. This also applies to individual features of the referenced devices and any combinations of these features. This document also describes devices for locating and releasing and for actuating.

According to an aspect, there are a plurality of parallel proportioning apparatus being at a constant spacing from each other and/or at least one proportioning apparatus which is adapted to be connected to a plurality of proportioning modules in a parallel alignment and at a constant spacing from each other. This system allows to perform automatic proportioning with a plurality of proportioning modules in a parallel alignment and at a constant spacing from each other. For instance, the spacing corresponds to the spacing of the wells on a certain type of microtitration plates (e.g. including 96, 384 or 1,536 wells) or the spacing of points (which need not necessarily be adjacent) on a base board. This also allows for parallel proportioning procedures with no contamination or carry-over.

The substrates onto which the sample liquid is to be proportioned particularly are vessels, vessel chains, microtitration plates (e.g. having 96, 384 or 1,536 wells), and diaphragm microtitration plates. More substrates are base boards, specifically base boards in glass (“slides”), and semiconductor material (“chips”). According to an aspect, there is at least one device for storing substrates of different types. The system allows to process different substrates in a simultaneous, time-shifted or overlapping fashion.

According to an aspect, the device for storing substrates comprises a fixed or movable table including or not including mechanisms for supporting the substrates. According to an aspect, the device for storing substrates comprises a device for the temperature control of substrates, e.g. a device for cooling. This allows to bring the substrates to a temperature which corresponds to a desired temperature for the liquid sample.

According to an aspect, the device for shifting comprises a device connected to said control device to locate the proportioning apparatus on the device for shifting and to release the proportioning device from the device for shifting. According to another aspect, there is at least one device for storing proportioning apparatus and the device for locating and releasing the proportioning apparatus can be caused to travel, by means of the device for shifting, with respect to the device for storing proportioning apparatus in order to exchange proportioning apparatus between the device for locating and releasing proportioning apparatus and the device for storing proportioning apparatus. This allows for an automatic exchange of the proportioning apparatus to employ proportioning apparatus for differently configured proportioning modules or exchange inoperative proportioning apparatus, for instance.

According to an aspect, the device for shifting comprises a device for driving the displacement chamber and the device for locating and releasing the proportioning apparatus has a disengageable coupling device for the transfer of the driving motion of the device for driving to the device for actuating the displacement chamber. Thus, different proportioning apparatus are able to operate with the same device for driving. Specifically, the device for locating and releasing the proportioning apparatus is configured like the tool holder according to the German Patent Application 102 47 731. In particular, the part of the proportioning apparatus which is adapted to be connected to the device for locating and releasing the proportioning apparatus is configured like that part of the proportioning apparatus which is adapted to be connected to the tool holder according to the German Patent Application 102 47 731. The features concerned are incorporated into the present application by way of reference to the foregoing document. This applies to both individual features and any combinations thereof that are described in the document.

The device for shifting may be a randomly configured handling robot.

According to an aspect, the device for shifting comprises a device for causing said proportioning apparatus to travel along one, two or three spatial axes and/or about one, two or three rotational axes.

According to an aspect, the device for shifting comprises a device for shifting the device for storing proportioning modules and/or the device for storing substrates and/or the device for storing proportioning apparatus along one, two or three spatial axes and/or about one, two or three rotational axes.

According to an aspect, the control device simultaneously controls a shift of the proportioning apparatus with respect to the device for storing substrates by means of said device for shifting and the proportioning of a sample liquid onto said substrates by means of said device for actuating the displacement chamber. This enables sample liquid to be proportioned onto the substrates during a shift of the substrates with respect to the proportioning apparatus, i.e. to effect proportioning “on the flight”.

It is understood that the proportioning apparatus and the device for shifting are provided with appropriate actuators and/or motor-operated drives to locate and release proportioning modules, actuate the displacement chamber, and bring about the shift.

According to an aspect, the system is integrated in an automatic proportioner or laboratory-type automatic machine (“working station” or “workstation”).

### BRIEF DESCRIPTION OF THE SEVERAL VIEWS OF THE DRAWINGS

FIG. 1 shows a roughly schematic block diagram of an inventive system;

FIG. 2 shows a proportioning apparatus, proportioning module, receptacle, handling frame, and cooling block of the system in a perspective, exploded view;

FIG. 3 shows the same components of the system as fitted into each other in the same perspective view.

### DETAILED DESCRIPTION OF THE INVENTION

While this invention may be embodied in many different forms, there are described in detail herein a specific preferred embodiment of the invention. This description is an exemplification of the principles of the invention and is not intended to limit the invention to the particular embodiment illustrated

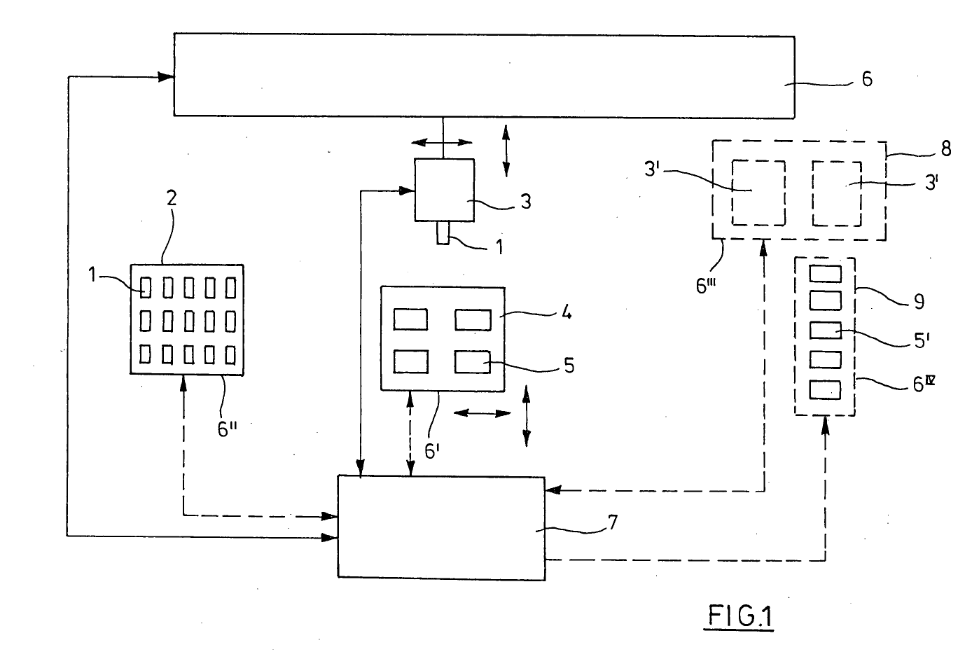

According to FIG. 1, the inventive system comprises a multiplicity of proportioning modules 1 which are stored in a device 2 for storing proportioning modules. The details of the proportioning module 1 are not shown in the drawing. It comprises a module casing in which a displacement chamber is disposed which has an outwardly leading proportioning outlet.

In addition, there is a proportioning apparatus 3 which is releasably connected to a proportioning module 1. The proportioning apparatus 3 comprises devices (not shown) for locating the proportioning module 1 on the proportioning apparatus 3 and releasing the proportioning module from the proportioning apparatus 3. It further comprises a device (not shown) for actuating the displacement chamber of the proportioning module 1 located on the proportioning apparatus 3.

A device 4 for storing substrates has disposed thereon a plurality of substrates 5.

Further, there is a device 6 for shifting the proportioning apparatus. The device 6 for shifting enables the proportioning apparatus 3 to travel in a plane parallel to the substrates 5 on the device 4 for storing substrates.

Further, there is an electronic control device 7 which is connected to the proportioning apparatus 3 and the device 6 for storing. The control device 7 controls the location and release of proportioning modules 1 on and from the proportioning apparatus 3 and the movements of the proportioning apparatus 3. The user is capable of controlling the system by means of input and output devices, which are not shown.

Controlling the movement of the proportioning apparatus 3 and its devices for locating and releasing the proportioning module 1 allows to remove proportioning modules 1 from the device 2 for storing or to be supplied thereto. Controlling the movement of the proportioning apparatus 3 and the device for actuating the displacement chamber allows to proportion sample liquid onto substrates 5 on the device 4 for storing from the prefilled proportioning module 1.

Variants of the system are marked by phantom lines and indexed reference numbers.

According to a variant, the device 6 for shifting has a device 6′ for shifting by means of which the device 4 for storing substrates can be shifted. The device 6′ for shifting is also controlled by the control device 7. Proportioning can be performed while shifting the device 4 for storing.

According to a further variant, the device 6 for shifting has another device 6″ for shifting which is associated with the device 2 for storing proportioning modules. The device 6″ for shifting is able to shift proportioning modules 1 to positions in which they can be easily picked up by the proportioning apparatus 3. This is also controlled by the control device 7.

A device 8 for storing proportioning apparatus has stored therein further proportioning apparatus 3′. The device 6 for shifting allows to insert proportioning apparatus 3 into the device 8 for storing proportioning apparatus and to remove proportioning apparatus 3′ therefrom. Also, the device 8 for storing proportioning apparatus can contain other tools, e.g. a gripping tool which is connected to the device 6 for shifting instead of the proportioning apparatus 3, if required.

Further substrates 5′ are contained in a magazine 9. The substrates 5′ can be transferred to the device 4 for storing substrates, in case of need. For instance, this can be accomplished by means of a gripping tool which is stored in the device 8 for storing proportioning apparatus.

The device 8 for storing proportioning apparatus and the magazine 9 can have associated therewith further devices 6′″, 6^{IV} for shifting which provide the proportioning apparatus 3′ or substrates 5′ in appropriate removal positions or withdraw them from appropriate removal positions.

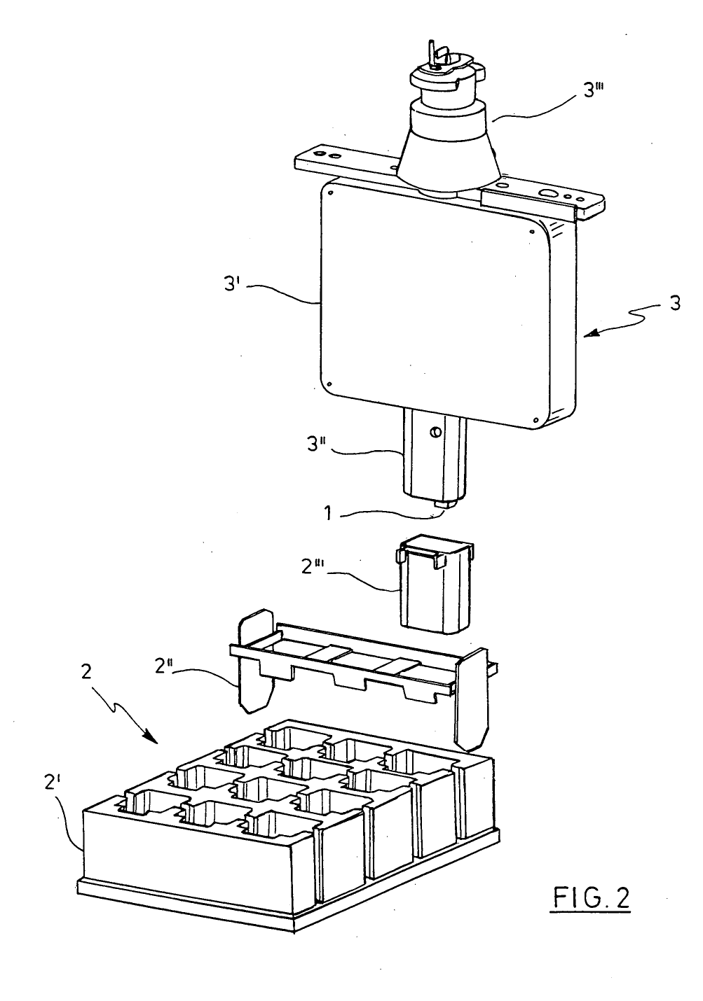

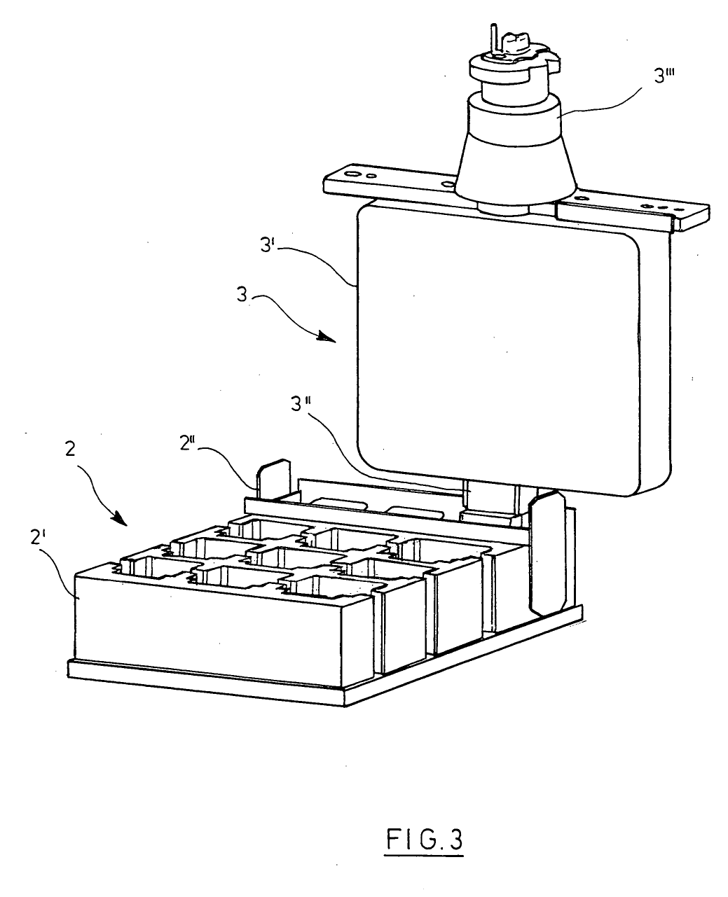

According to FIGS. 2 and 3, the device 2 for storing proportioning modules comprises a tray 2′, one or more handling frames 2″, and one or more receptacles 2′″. This design corresponds to the embodiment of FIGS. 8 through 15 of the German Patent Application 101 33 062.

The proportioning tool 3 has a casing 3′ with a lower end portion 3″ in which proportioning modules 1 are housed. The configurations of the proportioning module 1 and lower end portion 3″ correspond to the configurations of the proportioning module and the lower end portion of the proportioning apparatus of FIGS. 1 and 2 of the aforementioned Patent Application.

At top, the casing 3 is adapted to be connected to a coupling region 3′″ for a connection to the device 6 for shifting. The configuration of this mounting region, which also transmits a driving motion, corresponds to that of the top part of the proportioning tool of FIGS. 4 through 6 of the German Patent Application 101 33 062.

Proportioning modules 1 can be inserted into and removed from the device 2 for storing as shown in FIGS. 1 and 2 by shifting the proportioning tool 3 with respect to the device 2 for storing.

The above disclosure is intended to be illustrative and not exhaustive. This description will suggest many variations and alternatives to one of ordinary skill in this art. All these alternatives and variations are intended to be included within the scope of the claims where the term “comprising” means “including, but not limited to”. Those familiar with the art may recognize other equivalents to the specific embodiments described herein which equivalents are also intended to be encompassed by the claims.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

What is claimed is:

1. A system for proportioning sample liquids, comprising
at least one proportioning module (1) prefilled with a sample liquid which has a module casing in which a displacement chamber having an outwardly leading proportioning outlet is disposed,
at least one device (2) for storing proportioning modules,
at least one proportioning apparatus (3) with a device for locating at least one proportioning module (1) on the proportioning apparatus (3) and releasing the proportioning module (1) from the proportioning apparatus (3), and a device for actuating the displacement chamber of the proportioning module (1) located on the proportioning apparatus (3),
at least one device (4) for storing substrates onto which a sample liquid is to be proportioned,
a device (6) for shifting the proportioning apparatus (3) with respect to the device (2) for storing proportioning modules and the device (4) for storing substrates for an exchange of proportioning modules (1) between the proportioning apparatus (3) and the device for storing proportioning modules (2) and for the proportioning of sample liquid onto substrates (5) on the device (4) for storing substrates, and
a control device connected to the devices for locating and releasing and for actuating the proportioning apparatus (3) and the shifting device (6).

2. The system according to claim 1 wherein said device (2) for storing proportioning modules comprises at least one receptacle (2′″) for keeping proportioning modules (1) and/or at least one handling frame (2″) for handling receptacles (2′″) and/or proportioning modules (1) and/or at least one tray (2′) for receiving proportioning modules (1) and/or handling frames (2″) and/or receptacles (2′″).

3. The system according to claim 2 wherein said device (2) for storing proportioning modules comprises at least one temperature-controllable tray (2′).

4. The system according to claim 3 wherein the temperature-controllable tray (2′) is a cooling block.

5. The system according to claim 1 herein said device (2) for storing proportioning modules comprises proportioning modules (1) containing various sample liquids.

6. The system according to claim 1 including a plurality of parallel proportioning apparatus (3) being at a constant spacing from each other and/or at least one proportioning apparatus (3) which is adapted to be connected to a plurality of proportioning modules (1) in a parallel alignment at a constant spacing from each other.

7. The system according to claim 1 wherein there is at least one device (4) for storing substrates which contains substrates (5) of various types.

8. The system according to claim 1 wherein said device (4) for storing substrates comprises a fixed or movable table including or not including mechanisms for supporting substrates (5).

9. The system according to claim 1 wherein said device (4) for storing substrates comprises a device for the temperature control of substrates (5).

10. The system according to claim 1 wherein said device (6) for shifting has a device connected to said control device (7) to locate said proportioning apparatus (3) on said device (6) for shifting and to release said proportioning device from said device (6) for shifting.

11. The system according to claim 10, including at least one device (8) for storing proportioning apparatus wherein said device for locating and releasing said proportioning apparatus (3) can be caused to travel, by means of said device (6) for shifting, with respect to said device (8) for storing proportioning apparatus in order to exchange proportioning apparatus (3) between said device for locating and releasing said proportioning apparatus (3) and said device (8) for storing proportioning apparatus.

12. The system according to claim 10 wherein said device (6) for shifting has a device for driving said displacement chamber and said device for locating and releasing said device (6) for shifting has a disengageable coupling device for the transfer of the driving motion of said device for driving to said device for actuating said displacement chamber.

13. The system according to claim 1 wherein said device (6) for shifting comprises a device for causing said proportioning apparatus (3) to travel along one, two or three spatial axes and/or about one, two or three rotational axes.

14. The system according to claim 1 wherein said device (6) for shifting comprises a device for shifting said device (2) for storing proportioning modules and/or said device (4) for storing substrates and/or said device (8) for storing proportioning apparatus along one, two or three spatial axes and/or about one, two or three rotational axes.

15. The system according to claim 1 wherein said control device simultaneously controls a shift of said proportioning apparatus (3) with respect to said device (4) for storing substrates by means of said device (6) for shifting and the proportioning of sample liquid onto said substrates (5) by means of said device for actuating the displacement chamber.
